(19) United States
(12) Patent Application Publication
(10) Pub. No.: US 2003/0031315 A1
(43) Pub. Date: Feb. 13, 2003

(54) Echo canceller having nonlinear echo suppressor for harmonics calculations

(76) Inventors: Harm Jan Willem Belt, Leuven (BE); Cornelis Pieter Janse, Eindhoven (NL); Ivo Leon Diane Marie Merks, Eindhoven (NL)

Correspondence Address: U.S. Philips Corporation, 580 White Plains Road, Tarrytown, NY, 10591, US

(21) Appl. No.: 10/196,119

(22) Filed: Jul. 16, 2002

(30) Foreign Application Priority Data
Jul. 20, 2001 (EP) 01202792.6

(51) Int. Cl. H04M 9/08

(52) U.S. Cl. 379/406.01

(57) ABSTRACT

Disclosed is a communication system having stations mutually coupled through a communication channel, wherein at least one of the stations is provided with echo cancelling (EC) means. The EC means comprise: adaptive EC means arranged for simulating linear echo effects in said station, a subtracter coupled to the adaptive EC means and having a subtracter output, and non linear EC means coupled to the subtracter output for simulating additional echo effects in the communication station. The non linear EC means are arranged as harmonic suppressing post processor means coupled to the subtracter output for effecting non linear echo cancellation based on outputted higher harmonics. It is thus presented a low cost algorithm for full duplex acoustic echo cancellation, wherein a frequency dependent non linearity attenuation deals with non linearly distorted echo components. The system is well suited for robust hands free communication by mobile phones, video phones, conferencing phones etc.

The present invention relates to a communication system having stations mutually coupled through a communication channel, wherein at least one of the stations is provided with echo cancelling (EC) means comprising: adaptive EC means arranged for simulating linear echo effects in said station, a subtracter coupled to the adaptive EC means and having a subtracter output, and non linear EC means coupled to the subtracter output for simulating additional echo effects in the communication station.

The present invention also relates to an echo canceller means for application in the communication system and to an echo cancelling method in such a communication system, wherein echo due to linear components included in the communication system is cancelled.

Such echo cancelling is known from WO 97/45995. The known echo cancelling provides suppression of an interfering component such as echo effects, which are due to linear distortion in the communication system. The communication system has stations for near end and far end speakers, which stations are mutually coupled through a communication channel. The station comprises a loudspeaker microphone combination mutually coupled through an audio echo path, and echo cancelling means. The echo cancelling—hereafter EC—means comprises an echo canceller coupled to the loudspeaker for estimating a linear part of the audio echo path. Inputs of a subtracter are coupled to the microphone and the EC means respectively. The EC system also comprises a EC means in the form of a non linear processor (filter) coupled to a subtracter output. The non linear processor is arranged for reducing additional linear echoes not completely dealt with by the linear echo canceller.

It is however a disadvantage of the known communication system that it is not capable of dealing with echo effects arising from non linear components in the communication system.

Therefore it is an object of the present invention to provide a communication system having improved echo cancelling properties, such that it is capable of dealing with various types of linear as well as non linear echo effects.

Thereto the communication system according to the invention is characterised in that the non linear EC means are arranged as harmonic suppressing post processor means coupled to the subtracter output for effecting non linear echo cancellation based on outputted higher harmonics.

The present invention advantageously makes use of the fact that harmonics are well known to be due to non linear components in the communication system. These so called non linearity's may arise for example from the mechanics in the system or may be caused by non linear distortions in the echo path, for example by loudspeakers or amplifiers, such as loudspeaker amplifiers, or filters in the system, which may saturate due to input or line signal amplitudes which are too large, or due to a non linear behaviour of components, semiconductors or the like applied in the communication circuitry concerned. Suppression of these harmonics by the harmonic suppressing post processor means to the extent, wherein these disturbing harmonics are due to the non linearity's is presented as a powerful tool for tailored and fine tuned non linear echo cancellation. Near end speaker signal frequencies are left intact, even if they arise at harmonic frequencies of non linear far end echo signals. Finally linear echo effects, residual linear echo effects, as well as non linear echo effects are being suppressed adequately by the communication system according to the invention.

An embodiment of the communication system according to the invention is characterised in that the harmonic suppressing means are controlled to operate effectively once a line communication signal level in the system gives rise to substantial harmonic distortion.

It is an advantage of this embodiment of the communication system according to the invention that the harmonic suppressing means only come into operation if a line signal level in the communication system is such that non-linear distortions can be expected and/or actually arise.

A further embodiment of the communication system according to the invention is characterised in that the harmonic suppressing means comprise spectral gain calculating means for calculating a spectral gain function for the suppression of said harmonics.

It is an advantage of the communication system according to the invention that calculations related to the calculation of spectral gain functions or amplitudes of the spectral frequency components of the representative communication signal in the system can be accomplished relatively simple for example by means of an appropriate Fast Fourier Transform (FFT) algorithm.

A still further embodiment of the communication system according to the invention is characterised in that the harmonic suppressing means are arranged for taking into account non linearities having memory.

This embodiment advantageously deals with non linearities showing a reverberation or memory effect.

At present the communication system according to the invention will be elucidated further together with its additional advantages, while reference is being made to the appended drawing, wherein similar components are being referred to by means of the same reference numerals. In the drawing:

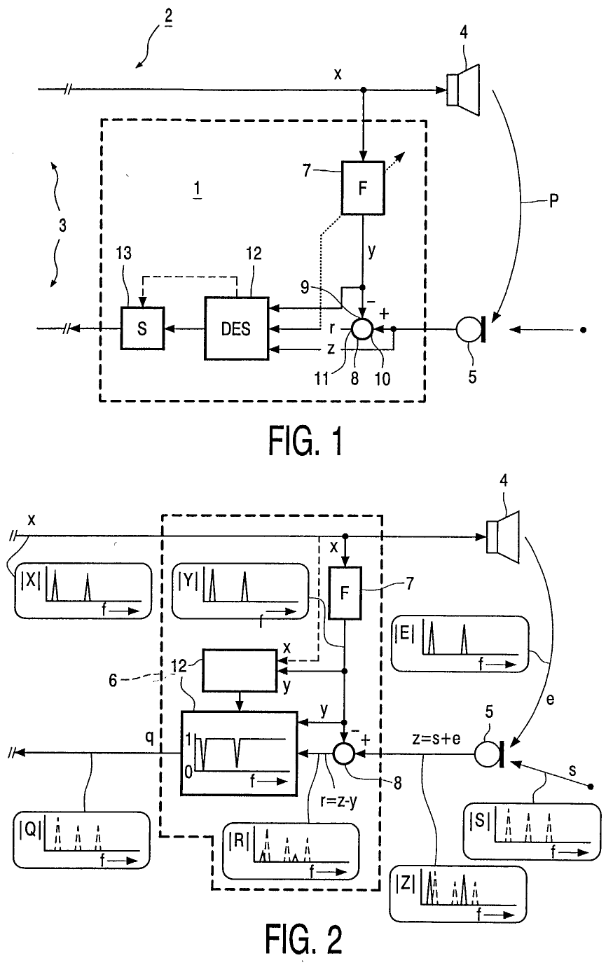

FIG. 1 shows a schematic view of a possible embodiment of the communication system according to the invention;

FIG. 2 shows an acoustic echo canceller having post processor means for linear echo cancellation in a communication system according to the prior art;

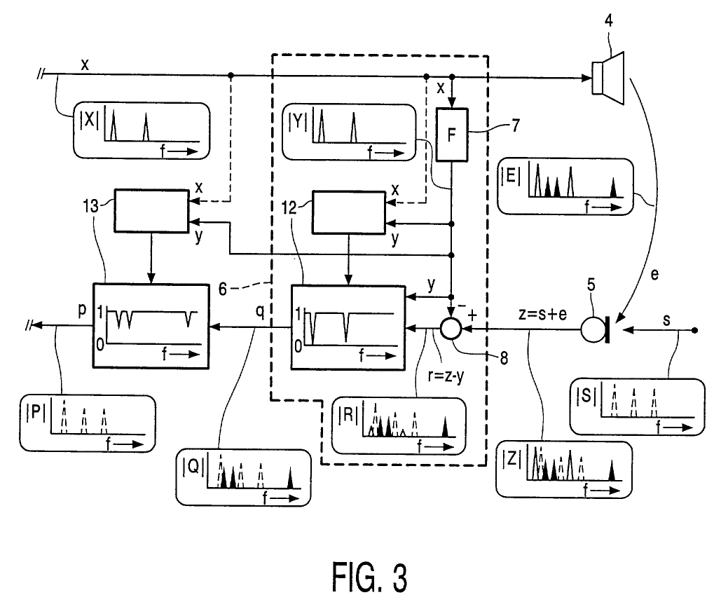

FIG. 3 shows an acoustic echo canceller having post processor means for both linear and non linear echo cancellation in the communication system of FIG. 1; and

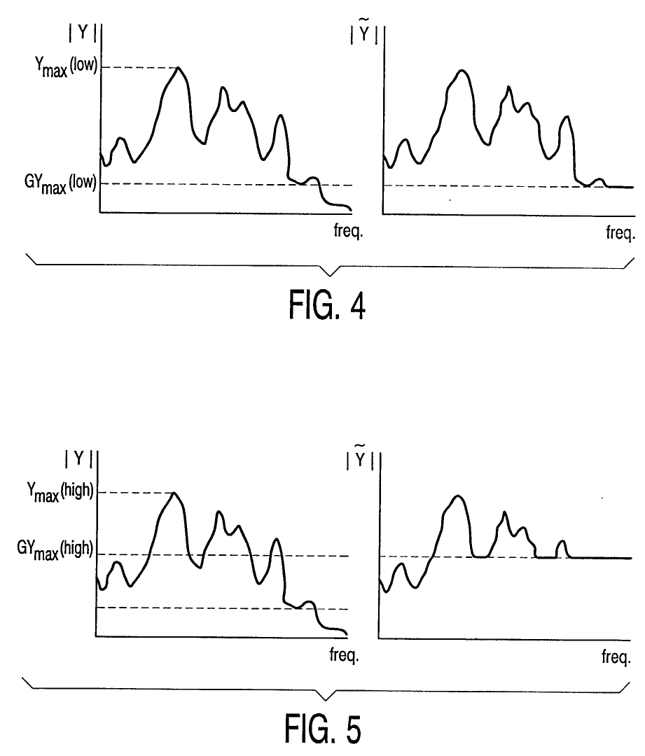

FIGS. 4 and 5 show magnitude spectra for explaining the operation of the post processor means of FIG. 3 for non linear echo cancellation.

FIG. 1 shows one station 1 of a communication system 2. Generally the communication system 2 comprises two or more of such stations 1 mutually coupled to each other through a possibly bi-directional communication channel 3. The communication system 2 may for example be an audio- and/or video conferencing system or a mobile phone system. Such systems may or may not be hands free systems. The system 2 comprises at least one audio path P in the embodiment of FIG. 1 formed by a loudspeaker 4 and a microphone 5. A so called line signal is conveyed over the channel 3 possibly via a hybrid or fork circuit and via several line amplifiers and filters (not shown), from a far end station having a far end speaker to the near end station 1 having a near end speaker.

Such a station 1 is provided with echo cancelling (hereinafter EC) means 6 for cancelling echo arising from the fact that a part of the line signal output by the loudspeaker 4 is fed back through echo path P to the microphone 5, which is heard by a far end listener, and vice versa is heard by a near end listener. The EC means 6 comprise adaptive EC means 7 essentially coupled in parallel to the echo path P. The EC means 6 simulate linear echo effects of the echo path P in said station 1. Several suitable adaptive filtering algorithms can be found in the textbook entitled—Adaptive Filter Theory—by S. Haykin, Prentice-Hall, (NJ, USA), ISBN 0-13-004052-5025, incorporated here by reference thereto. Some suitable adaptive filtering algorithms are for example the (normalised) least-mean-square algorithm, the frequency domain adaptive filter algorithm, and the affine projection algorithm. On top of the chosen filtering algorithm a proper mechanism is needed to halt or at least slow down the filter coefficient adaptation process applied in the EC means 6, when the near end speaker becomes active. Ideally the adaptive filter imitates the linear part of the transfer function between the loudspeaker 4 and the microphone 5, and estimates the far echo received by the microphone 5. The EC means 6 further comprise a subtractor 8 having two inputs 9, 10 and an output 11. Subtracter input 9 is coupled to the adaptive EC means 7 and its input 10 is coupled to the microphone 5. After subtraction of the echoes estimated by the adaptive EC means 7 from the microphone signal on input 10 only a near end speaker signal remains at subtracter output 11.

In practice it appears that such an adaptive EC means 7 is only capable of partly removing echoes in the communication system 1. The EC means 6 in the system 1 also comprises dynamic EC means 12 coupled to the subtracter output 11. These dynamic EC means 12 are capable of additionally dealing with the dynamic echo effects of linear distortion, such as movements in the room of a speaker. This arises particularly if the communication system 1 is a hands free system, having one or more hands free and movable stations 1. Then the acoustic properties in the room change continuously causing tracking difficulties in the adaptive EC means 6. Furthermore these EC means 6 may have too few coefficients to accurately model the true transfer function of the path or paths P, leading to poor linear echo cancelling results. The dynamic EC means 12 form a spectral post processor, which simultaneously deals with movements in the room and under-modelling, and provides sufficient additional linear echo suppression at all times. Details of the operation and arrangement of the dynamic EC means 12 can be found in applicants published International patent application WO 97/45995, whose content is included here by reference thereto.

At present referring to FIG. 2 the operation of the EC spectral processor means 12 will be explained. Herein example frequency spectra are plotted in a double talk situation, where the undesired echo components are indicated with solid lines and the desired near end components are indicated with dotted lines. The far end speaker produces a line signal x having a magnitude frequency spectrum |X|. The microphone receives an undesired acoustic echo e having a magnitude frequency spectrum |E|, plus a desired near end signal s having a magnitude frequency spectrum |S|. The adaptive EC means 7 filter the loudspeaker signal x to produce an estimated echo signal y having a magnitude frequency spectrum |Y|. Due to under modelling and movements in the room wherein the speaker resides the residual signal r is not completely free of echoes, which can be seen from the example residual magnitude spectrum |R|. Both signals y and r serve as inputs for the dynamic EC means, also called Dynamic Echo suppresser or DES 12, which further suppresses residual echoes. To this end the DES 12 calculates a spectral gain function A from the signal y. As indicated by the dotted line this function A could also be calculated from the signal x. Output q of the DES 12 is reconstructed from the modified magnitude spectrum |A | |R| and from the unmodified phase of R. The signal q is free of linear echoes and still contains the desired near end signal s, as can be seen from its magnitude frequency spectrum.

Next, the calculation of the gain function A is explained in further detail. The DES 12 collects at its input frames of B samples, windows the input data, and transforms the results to spectral magnitude components, denoted by |Y(f;l_{B})|, |Z(f;l_{B})| and |R(f;l_{B})| with f the frequency index and l_{B} the data frame index which is increased by unity after every B sampling instants. Next the DES 12 applies a frequency dependent (non-negative) attenuation A(f;l_{B}) to |R(f;l_{B})| according to:

A(f;l_{B})=max [{|Z(f;l_{B})|−γₑ|Y(f;l_{B})|}/|R(f;l_{B})|,0],∀f

Where γₑ is a constant called the echo subtraction factor, which is typically slightly larger than 1. Further, when A(f,l_{B})>1 at a certain frequency, A(f;l_{B}) is set to 1. Thus in bands with a strong far end echo (note y is an estimate of the echo) compared to the near end signal the residual signal r is attenuated, and in bands where the near end signal is much stronger than the far end echo the residual signal r remains approximately the same. Finally the attenuated residual signal is transformed back to the time domain, for which the original phase at the input of the dynamic EC means 12 is used. The combination processing by the adaptive EC means 7 and the dynamic EC means 12 provides a very robust full duplex algorithm, which is capable of dealing with movements in the room, which change the acoustic properties, such as reverberation in the room (which cannot be dealt with by the adaptive EC means 7) and with under modeling.

Various modifications can be made to the above linear echo cancellation processing. When for example an estimate of noise in the microphone signal is available, the DES 12 can based on the noise magnitude spectrum |N(f;l_{B})| achieve noise suppression. The attenuation A(f;l_{B}) is then given by:

A(f;l_{B})=max[{|Z(f;l_{B})|−γₑ|Y(f;l_{B})|−γₙ|N(f;l_{B})|}/R(f;l_{B})|,0],∀f

where γₙ is the noise subtraction factor.

Further it is possible to increase |Y(F;l_{B})| with an estimated reverberation tail of the acoustics, which was not covered by the (short) adaptive EC means 7.

As another example the attenuation A(f;l_{B}) of consecutive frames are low pass filtered over time to achieve more gradual frame transitions.

FIG. 3 shows an acoustic echo canceller means 6 having the dynamic EC means 12 and a non linear post processor echo cancelling means 13 for application in the communication system 1. The non linear EC means 13 are coupled to the subtracter output 11 through the EC means 12. The non linear EC means 13 are arranged as harmonic suppressing post processor means connected to the dynamic EC means 12 for effecting non linear echo cancellation based on outputted higher harmonics.

Next the operation of the non linear EC means 13 will be explained. The non linear EC means 13 specifically remove the non linear echo components of the output signal q using a special spectral subtracter. The depicted example spectra explained in the foregoing now also contain harmonics of the non linear echo components, indicated in black in FIG. 3. The output q of the DES 12 still contains echo components, namely the non linear harmonics. From the output signal y of the adaptive EC means 7 a spectral gain function B(f;l_{B}) is calculated for the suppression of these harmonics. To this end one could also use the signal x, hence the dotted line. The output p of the non linear spectral harmonic suppressing post processor means is reconstructed from the modified magnitude spectrum |B(f;l_{B})| |Q(f;l_{B})| and the unmodified phase of Q(f;l_{B}), which is identical to the phase of R(f;l_{B}). The spectral gain function B(f;l_{B}) is taken such that the overall gain function Ã(f;l_{B})=A(f;l_{B})B(f;l_{B}) becomes:

Ã(f;l_{B})=max [{|Z(f;l_{B})|−γₑ|¥(f;l_{B})|}/R(f;l_{B})|,0],∀f

Again when Ã(f;l_{B})>1 at a certain frequency Ã(f;l_{B}) is set to 1. It is to be noted that in practice it is the combined gain Ã(f;l_{B}) above that is implemented and the gains A(f;l_{B}) and B(f;l_{B}) do not exist separately. The spectrum |¥(f;l_{B})| is a spectrally shaped version of |¥(f;l_{B})|, and is determined by:

|¥(f;l_{B})|=max [|¥(f;l_{B})|, G(y;l_{B})Yₘₐₓ(f;l_{B})], ∀f(1)

where

Yₘₐₓ(f;l_{B})=max [|Y(f₀)|], with f₀ε[0, f]

and where G(y;l_{B}) (0≦G(y;l_{B})≦1) is a real number, which is proportional to the estimated echo level, and

G(y;l_{B})=G₀(P_{y,direct}(l_{B})+P_{y}, diffiuse(l_{B})).

Here G₀ is a fixed constant such that 0≦G(y;l_{B})≦1 and P_{y,direct}(l_{B}) is the power of the estimated direct echo contribution given by:

$${P}_{y , direct} ( {l}_{B} ) = D {\sum }_{n = 0}^{B - 1} {y}^{2} ( {l}_{B} B + n )$$

where D (0≦D≦1) is a fixed parameter that is chosen according to the direct/diffuse sound ratio of the output y of the adaptive EC means 7. The power contribution P_{y,diffiuse}(l_{B}) of the total diffuse sound can then be calculated as a first order recursion on the power contribution of the diffuse part of the output y of the adaptive EC filter means 7 (where the diffuse part is given by:

$$( 1 - D ) {\sum }_{n = 0}^{B - 1} {y}^{2} ( {l}_{B} B + n ) )$$

with memory parameter αᵣₑᵥ as:

$${P}_{y , diffuse} ( {l}_{B} ) = {α}_{rev} {P}_{y , diffuse} ( {l}_{B} - 1 ) + ( 1 - {α}_{rev} ) ( 1 - D ) {\sum }_{n = 0}^{B - 1} {y}^{2} ( {l}_{B} B + n ) .$$

A good value for αᵣₑᵥ is given by:

αᵣₑᵥ=10^{-q}, with q=6B/(FₛT₆₀)

where Fₛ is the sampling frequency and T₆₀ is the reverberation time of the room acoustics.

The combined effects of the above mentioned non linear post processing by the means 13 is as follows. At low echo levels, when non-linearities are expected to be negligible, G(y;l_{B}) will be a small number and Ã(f;l_{B})≈A(f;l_{B}) so that the non-linearity suppressing means 13 is effectively disabled. At increasing echo levels the relative echo distortion will increase. This behavior is simulated by an increasing values of G(f;l_{B}). With increasing G(fl_{B}) it is achieved that at frequencies where non linear harmonics can be expected we get Ã(f;l_{B})<A(f;l_{B}), so that the non linear echoes are suppressed.

By way of example FIGS. 4 and 5 show magnitude spectra for explaining the operation of the non linear harmonic suppressing means 13. In both figures the left plot shows the short time magnitude spectrum |Y(f;l_{B})| of the output signal y. In FIG. 4 the absolute level of |Y(f;l_{B})| is much smaller than in FIG. 5, which is schematically shown by the indications “(low)” and “(high)”. The right plots of both figures show the shaped magnitude spectrum |¥(f;l_{B})| for both cases. In FIG. 4 the echo level is small, so no non linearities are expected, G(f;l_{B}) is small, and with equation (1) we have |¥(F;l_{B})|≈|Y(f;l_{B})|. In FIG. 5 the echo level is so large that non linearities are expected, G(f;l_{B}) is much larger, and with equation (1) it is achieved that at frequencies where non linearities can be expected it holds that |¥(f;l_{B})|>|Y(f;l_{B})|, so that Ã(f;l_{B})<A(f;l_{B}) and non linearities are suppressed. At the same time, during double talk there will be many frequencies where the near end signal magnitude is larger than |¥(f;l_{B})|(yielding Ã(f;l_{B})>0) so that the near end speaker can interrupt the far end speaker and full duplex communications remain possible.

A further extension of equation (1) takes into account that the non linearities can have memory. It is then not sufficient to only take into account the current |Y(f;l_{B})| for the calculation of |¥(f;l_{B})| as is done in equation (1). Memory which may be incorporated in various known ways may for example be incorporated by:

|¥(f;l_{B})|=β|¥(f;l_{B}−1)|+(1−β)max[|Y(f;l_{B})|,G(y;l_{B})Yₘₐₓ(f;l_{B})],∀f

where β is a fixed parameter (0≦B<1) that can be tuned to the expected memory of the non linearities.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now within reach of the skilled person. Also the algorithm above can directly be extended to multi channel full duplex systems, which either have multiple microphones or multiple loudspeakers.

1. A communication system (2) having stations (1) mutually coupled through a communication channel (3), wherein at least one of the stations (1) is provided with echo cancelling (EC) means (6) comprising: adaptive EC means (7) arranged for simulating linear echo effects in said station (1), a subtracter (8) coupled to the adaptive EC means (7) and having a subtracter output (11), and non linear EC means (12, 13) coupled to the subtracter output (11) for simulating additional echo effects in the communication station (2), characterised in that the non linear EC means (13) are arranged as harmonic suppressing post processor means coupled to the subtracter output (11) for effecting non linear echo cancellation based on outputted higher harmonics.

2. The communication system (2) according to claim 1, characterised in that the harmonic suppressing means (13) are controlled to operate once a line communication signal level in the system (2) gives rise to substantial harmonic distortion.

3. The communication system (2) according to claim 1 or 2, characterised in that the harmonic suppressing means (13) comprise spectral gain calculating means for calculating a spectral gain function for the suppression of said harmonics.

4. The communication system (2) according to one of the claims 1-3, characterised in that the harmonic suppressing means (13) are arranged for taking into account non linearities having memory.

5. Echo canceller means (6) for application in the communication system (2) according any of the claims 1-4.

6. An echo cancelling method, wherein echo due to linear components in the communication system (2) is cancelled, characterised in that data used to cancel the echo due to the linear components is being used to derive therefrom harmonics data for cancelling echo due to the non linear components.
